(19) United States
(12) Patent Application Publication
(10) Pub. No.: US 2014/0147548 A1
(43) Pub. Date: May 29, 2014

(54) MILK REPLACER PRODUCTS HAVING ADJUSTED FATTY ACID PROFILES AND METHODS OF FEEDING SAME

(71) Applicant: PURINA ANIMAL NUTRITION LLC, Shoreview, MN (US)

(72) Inventors: Bill L. Miller, Labadie, MO (US); Robert Musser, Woodbury, MN (US); Madhu Kakade, Roseville, MN (US)

(73) Assignee: PURINA ANIMAL NUTRITION LLC, Shoreview, MN (US)

(21) Appl. No.: 13/686,662

(22) Filed: Nov. 27, 2012

(51) Int. Cl. A23C 11/06

(52) U.S. Cl. CPC A23C 11/065
USPC 426/2; 426/648

(57) ABSTRACT

Milk replacers include a fat component in which least about 10 percent of the total fat content is formed of medium chain triglycerides. Young animals consuming the milk replacer ingest the medium chain triglycerides at a rate of at least about 13.5 grams per head per day and exhibit improved animal performance. The milk replacers with the modified fatty acid profiles may include a reduced level of fat and protein compared to traditional milk replacers without negatively affecting performance of young animals, and may even enhance performance of the young animals. These milk replacers may be produced by adding the medium chain triglycerides during milk replacer formulation, and at least about 9 grams of medium chain triglycerides are provided per pound of milk replacer.

### TECHNICAL FIELD

The present disclosure relates to milk replacers having adjusted fatty acid profiles and methods of feeding such milk replacers to young animals for improved animal performance. In some aspects, the milk replacers with the adjusted fatty acid profiles have one or both of a reduced fat content and reduced protein content relative to milk replacers used in prior approaches.

### BACKGROUND

Young animals such as young livestock animals, prior to and during weaning, are typically fed milk replacers. Milk replacers have been employed for over 60 years to sustain and grow the young animals such as bovine calves. Today, milk replacers for many species are available to safely grow infant animals and typically include a combination of protein and fat. For milk replacers, the protein is generally derived from milk and vegetable and animal protein, while the fat is typically lard, tallow, palm kernel and/or coconut oil. Because these fat sources support acceptable levels of performance, they may be viewed as being interchangeable relative to animal performance.

Work to determine the proper nutrient level and ingredient sources for calf milk replacers has been conducted during the last several decades. For example, lard has been employed as the primary fat source in milk replacers for many years, and attempts to improve this fat source over the last 20 years have been unsuccessful.

Consequently, although a number of milk replacer feeding systems have been used to enhance weight gain of livestock animals prior to and during weaning, such techniques have involved providing supplements and additives to milk replacer or starter, including small amounts of vitamins or medications.

### SUMMARY

The present disclosure provides milk replacers with a fat component formulated to selected fatty acid profiles and methods of feeding such milk replacers to young animals to improve performance.

In certain aspects, a milk replacer product for young animals includes a fat content of up to about 20 percent on a dry matter basis, where at least about 10 percent of the fat content is contributed by medium chain triglycerides on a dry matter basis.

In other aspects, a method of feeding a milk replacer to young animals involves providing the young animals the milk replacer containing medium chain triglycerides such that the young animals ingest the medium chain triglycerides at a rate of at least about 13.5 grams per head per day.

In still further aspects, a method of making a milk replacer for young animals involves adding medium chain triglycerides to a milk replacer formulation such that the milk replacer product includes at least about 9 grams of medium chain triglycerides per pound of milk replacer on a dry matter basis.

### DETAILED DESCRIPTION

Implementations provide milk replacers with a fat content having a modified fatty acid profile. It has been discovered that fat levels of animal milk replacers can be reduced substantially compared to milk replacers used in prior approaches when the fat component is formulated to provide fatty acids in a selected ratio, and young animals fed this improved milk replacer perform equally to cohorts fed milk replacers including a fat content formulated according to prior approaches. Further, it has been discovered that for these milk replacers formulated with selected fatty acid profiles, protein levels may be reduced relative to the protein levels in milk replacers used in prior approaches.

Milk replacers typically have a fat content ranging from between 15 and 30 percent on a dry matter basis, with the predominant fat source being lard, tallow, palm kernel or coconut oils alone or in combination. In addition, some fat from lecithin and residual fat (e.g., butter fat, milkfat or both) typically contributes to the fat content in these milk replacers. This traditional fat content generally includes low or background levels of medium chain triglycerides, e.g., from about 0.5 to about 0.75 percent of the total weight of the fat content on a dry matter basis, and the predominant form of fats in the milk replacers are non-medium chain triglycerides found in the lard, lecithin and residual fats. It has been discovered that by elevating the levels of medium chain triglycerides in the fat content of milk replacers, young animals such as calves experience improved performance.

Thus, according to certain aspects of the present disclosure, milk replacers include a fat content with a reformulated fat blend containing a modified fatty acid profile including elevated levels of medium chain triglycerides relative to traditional milk replacers. Medium chain triglycerides are medium chain fatty acid esters of glycerol with 6 to 12 carbons, and include caproic, caprylic, capric and lauric fatty acids and combinations thereof. For example, one or more of the aforementioned medium chain triglycerides may be provided as a mixture, and in a particular example, may include caprylic fatty acids between about 20 percent to about 80 percent, or about 55 percent to about 75 percent of the medium chain triglycerides; and capric fatty acids between about 20 percent to about 80 percent, or about 25 percent to about 45 percent of the medium chain triglycerides. Caproic and lauric fatty acids may also be provided at levels between 20 percent and 80 percent of the medium chain triglycerides. In some examples, the medium chain triglycerides may account for about or at least about 10 percent of the total fat content of the milk replacer on a dry matter basis. In further examples, the medium chain triglycerides may form about or up to about 40 percent of the fat content on a dry matter basis. The total fat content in the milk replacers of the present disclosure may from about 10 to about 35 percent by weight, or more particularly from about 10 to about 20 percent by weight, or up to or at about 10, 15, 20, 25, 30, or 35 percent by weight total fat on a dry matter basis.

In addition, supplemental fatty acids may be incorporated into the reformulated fat blend in order to supplement the fat content of the milk replacers of the present disclosure. For example, supplemental essential fatty acids, including omega-3 and omega-6 fatty acids, may provide benefits to animals beyond serving as an energy source, and one or more of these essential fatty acids may be included in the reformulated fat blend. For example, the reformulated fat blend may include a ratio of about 2:1 to about 7:1 of medium chain fatty acids to supplemental essential fatty acids. Such essential fatty acids may include, but are not limited to, linoleic acid and linolenic acid. In a particular example, canola oil, which includes elevated levels of linoleic and linolenic fatty acids relative to traditional fats may be present from between about 2 and about 5 percent of the total content of the fat in the milk replacer on a dry matter basis. Similar to canola oil, flaxseed oil, soybean oil, fish oil, algae oil and exotic oils may contribute elevated levels of linoleic and linolenic fatty acids, and may be included in the total fat content of the milk replacers of the present disclosure, e.g., at levels between about 2 and about 5 percent of the total content of the fat in the milk replacer on a dry matter basis. The addition of essential fatty acids in the reformulated fat blend may offset a reduction one or more of these fatty acids due to a reduction in traditional fats such as lard in the fat content. In another example, supplemental fatty acids such as butyric and myristic fatty acids may be included in the reformulated fat blend, and one or both of these may be provided at about 1 to about 4 grams per head per day.

Because the medium chain triglycerides, and optionally the supplemental essential fatty acids, account for a portion of the fat content of the modified fatty acid profile, this reduces the levels of some fatty acids commonly found in the fat content of milk replacers. For example, levels of palmitic, stearic, and oleic acids may be reduced in the milk replacers of the present disclosure relative to milk replacers used in prior approaches.

Protein in milk replacers typically accounts for between about 18 and about 30 weight percent of the milk replacer on a dry matter basis and may be sourced from milk, animal (e.g., plasma, egg and red blood cells) and vegetable ingredients and combinations thereof. For example, traditional milk replacers may include about 22 percent milk protein, and milk replacers formulated for enhanced performance (e.g., full potential milk replacers) may include about 26 to about 28 percent milk protein on a dry matter basis. It has been discovered that milk replacers with a modified fatty acid profile may include relatively reduced levels of protein compared to traditional and enhanced performance milk replacers. For example, as compared to traditional milk replacers and enhanced performance milk replacers, the protein level of the fatty acid reformulated milk replacers may be reduced by about 1 to 2 percent with similar or improved performance in the young animal. However, the fatty acid reformulated milk replacers may include any amount of protein, for example, ranging from about 18 and about 30 percent on a dry matter basis. Where non-milk proteins, such as vegetable proteins (e.g., soy protein), animal protein, and single cell proteins, are included as a protein source in the milk replacer, the non-milk protein may account for up to from about 1 to about 65 percent, from about 50 to about 65 percent, or up to or at about 50 or about 65 percent of the total protein content on a dry matter basis.

Reformulating the fat for use in the milk replacers of the present disclosure may involve replacing a portion of the traditional fats with a reformulated fat blend of one or more of the various medium chain triglycerides disclosed and supplemental fatty acids. As provided herein, the total fat content of the milk replacers may account for about 10 percent up to about 35 percent by weight of the milk replacer on a dry matter basis.

In some examples, the reformulated fat blend includes the medium chain triglycerides provided as individual fatty acids, fatty acid mixtures, and these may be sourced from fats that are rich in medium chain triglycerides such as palm kernel oil or coconut oil, and such fat sources may be modified fat sources to achieve elevated levels of medium chain triglycerides. Including supplemental fatty acids in the reformulated fat blend may balance the total fatty acid profile. Thus, the medium chain triglycerides, alone or in combination with supplemental fatty acids, may provide the reformulated fat blend used in the production of the final milk replacer products.

Milk replacers may be produced by adding the reformulated fat blend to a milk replacer formulation so that each pound of milk replacer includes at least about 9 grams and up to about 27.25 grams of medium chain triglycerides on a dry matter basis. Supplemental fatty acids may be provided in the milk replacer at a rate of about 1.14 to about 4.5 grams per pound. The level of medium chain triglycerides may, accordingly, account for between about 2.0 and 6.0 percent of the total weight of the milk replacer on a dry matter basis, while supplemental fatty acids may account for between about 0.25 to 1.0 percent of the total weight of the milk replacer on a dry matter basis.

In some aspects, the reformulated fat blend may be added at the time of milk replacer manufacture and may replace a portion of traditional fats used to formulate the milk replacers. The addition of the reformulated fat blend during manufacture may be applicable to all categories of milk replacers, including traditional, enhanced performance and full potential milk replacers. Typically, traditional milk replacers contain an 18 to 20 percent protein and a 15 to 20 percent fat content; full potential milk replacers contain a 25 to 30 percent protein and a 20 percent fat content; and enhanced performance milk replacers contain 20 to 22 percent protein and 20 percent fat. Alternatively, the reformulated fat blend may be added to milk replacers at the time of feeding. In this example, the milk replacer receiving the reformulated fat blend may be any category of milk replacer. Alternatively, whole milk may be supplemented with the reformulated fat blend of the present disclosure. For example, where a producer has insufficient whole milk to provide nutrients and dry matter to calves, the reformulated fat blend may be incorporated into a milk balancer and added to the whole milk, which may thereby serve as a milk replacer.

When delivered to young animals, the milk replacers including the reformulated fat blend of the present disclosure may be fed consistent with typical feeding practices and tag recommendations. For example, the milk replacers with a 10, 15 or 20 percent fat content on a dry matter basis (taking into account the reformulated fat blend) may be provided at rate of 1.5 pounds per head per day up to about 2.5 pounds per head per day during a pre-weaning stage (e.g., during the first 35 to 42 days of life or up to about 130 170 lbs.), and these amounts may be reduced by about 50 percent during weaning (e.g., after about 35 or about 42 days of life or upon reaching 140 to about 180 lbs.).

In particular aspects, for milk replacers fed at 1.5 pounds per head per day, medium chain triglycerides may account for at least about 13.5 grams and up to about 41 grams, or any value from 13.5 to 41 grams, of the 1.5 pounds of milk replacer, and supplemental fatty acids may account for at least about 1.5 grams up to about 6.75 grams, or any value from 1.5 to about 6.75 grams, of the 1.5 pounds of milk replacer.

For milk replacers fed at 2.5 pounds per head per day, such as enhanced performance milk replacers, the medium chain triglycerides may account for at least about 22.7 grams and up to about 68.1 grams, or any value from 22.7 to 68.1 grams; and supplemental fatty acids may account for at least about 2.5 grams and up to about 11.4 grams, or any value from 2.5 to 11.4 grams, of the 2.5 pounds of milk replacer.

Young animals ingesting the milk replacers having the reformulated fat blend experience the same or improved performance compared to young animals ingesting milk replacers used in prior approaches with a similar fat and protein content. Improved performance in the young animal may include, but is not limited to, improved weight gain, starter intake, feed to gain ratio, body measurements (hip height, hip girth and body length). In addition, in some cases, the young animals ingesting the milk replacers of the present disclosure outperform animals ingesting milk replacers used in prior approaches with a relatively elevated fat and/or protein content. For the young animal, improved performance through ingesting milk replacer with the reformulated fat blend may also reduce the cost of feeding the animal milk replacers, particularly when a reduced fat and/or protein content milk replacer containing the reformulated fat blend is ingested by the young animal. Furthermore, saleable ruminant milk such as cow's milk may be diverted to human uses through use of the more cost-effective milk replacers of the present disclosure. Moreover, formulation of the calf milk replacers to include the reformulated fat blend may additionally reduce total feeding costs, e.g., due to the reduction of total protein and fat levels ingested.

In addition, where improved performance results in an increased weight gain and body growth of the animal from an early age, this may facilitate the animal reaching an earlier puberty, breeding and lactation age in later stages in life. Consequently, this may reduce the age of a dairy cow at freshening and the onset of lactation, thereby reducing the cost of milk production. Increased weight gain of the livestock animal from an early age may also reduce the cost of beef production.

The benefits of providing young animals with milk replacers including the reformulated fat blends of the present disclosure are further displayed by the four example trials, Examples 1-4, which were conducted to assess the effects of reformulation of the fat component contained in calf milk replacer on calf performance. Although calf milk replacers were studied, it is believed that milk replacers with a reformulated fat component are beneficial for other young non-human animals, such as young livestock animals, companion animals and exotic animals. Accordingly, aspects of the present disclosure are described in the following Examples, which are intended for illustration only, and those skilled in the art will appreciate that modifications and variations may be made without departing from the scope of the present disclosure.

### Example 1

In Example 1, calves ingesting milk replacers with a reformulated fat component were studied against calves fed two traditional milk replacers, one containing 22 percent protein and 20 percent fat, and another containing 22 percent protein and 15 percent fat.

Procedures:

Ninety-six (96) 3-5 day old calves weighing approximately 95 to 105 pounds were assigned by row, weight and initial gamma globulin level (equal distribution within each of following groups: <0.49, 0.50 to 0.99, 1.00 to 1.49, 1.50 to 2.49, and >2.5% gamma globulin) into four groups of 24 calves, and the groups were randomly assigned to four treatment groups for the six-week study, e.g., to about 45 to about 49 days of age. In this Example, protein in the milk replacers was formed of all-milk protein.

The first and second control groups (control groups 1 and 2) received traditional milk replacers. For control group 1, calves received a calf milk replacer with 22 percent protein and 20 percent fat (Amplifier® Max); and for control group 2, calves received a calf milk replacer with 22 percent protein and 15 percent fat. The control milk replacers contained lard and lecithin as the sole fat sources. The first test group (test group 1) received a calf milk replacer with 22 percent protein and 15 percent fat containing a reformulated fat blend containing the modified fatty acid profile of the present disclosure; and the second test group (test group 2) received a calf milk replacer with 22 percent protein and 10 percent fat containing the reformulated fat blend with the modified fatty acid profile. For test groups 1 and 2, the fat in the fatty acid profile-modified milk replacers contained the reformulated fat blend including medium chain triglycerides at about 3.8 percent of the total weight of the milk replacer and canola oil at about 0.5 percent of the total weight of the milk replacer in combination with a traditional fat blend containing lard and lecithin to yield a 15 percent fat milk replacer (e.g., with the traditional fat blend accounting for 10.7 weight percent of the milk replacer) and 10 percent fat milk replacer (e.g., with the traditional blend accounting for 5.7 weight percent of the milk replacer) for test groups 1 and 2, respectively.

All groups were fed milk replacers at a 1.5 pound feeding rate, daily (split over two feedings) for five weeks. During the sixth week of the evaluation, milk replacer was reduced by half to facilitate calf weaning. A 20 percent protein calf starter was offered to all calves ad libitum.

Results:

Performance results of the calves fed the four different milk replacers during the six-week treatment period are presented in Table 1.

TABLE 1
Performance results after dietary treatment for six weeks

| | 22:20 | 22:15 | 22:15 Fatty | 22:10 Fatty | |
|---|---|---|---|---|---|
| | Control | Control | Acid Test | Acid Test | |
| Dietary Treatment | Group 1 | Group 2 | Group 1 | Group 2 | SE |
| Total Avg. | 150.8^{a} | 154.5^{ab} | 157.6^{ab} | 160.6^{b} | 3.1 |
| Weight, lbs. | | | | | |
| Total Avg. Gain, lbs. | 50.4^{a} | 53.8^{ab} | 57.2^{ab} | 60.2^{b} | 3.0 |
| Total Avg. Starter | 44.6^{a} | 45.8^{ab} | 51.1^{ab} | 53.4^{b} | 3.1 |
| Cons. lbs. (DM Basis) | | | | | |
| Total Avg. CMR lbs. | 53.7^{a} | 55.7^{b} | 54.6^{ab} | 55.3^{b} | 0.6 |
| (DM Basis) | | | | | |
| Average Feed: Gain | 2.2^{b} | 2.0^{ab} | 1.9^{a} | 1.8^{a} | 0.1 |

^{ab}Means in the same row not followed by a common letter differ (P < .05) using LSD procedure.

Referring to the performance results of Table 1, for control groups 1 and 2, calves fed the two control products performed in a similar manner at 50.4 and 53.8 average gained pounds after six weeks of the ingesting milk replacers containing 20 and 15 percent fat, respectively. For test groups 1 and 2, calves ingesting milk replacer formulated to provide the specific fatty acid ratio, on average, gained more weight than the control groups. For test group 1, calves fed the fatty acid formulated treatment containing 15 percent, on average, outgained the control group 1 and 2 animals by 3.4 pounds (6.3%) and 6.7 pounds (13.5%), respectively. For test group 2, calves fed the fatty acid formulated treatment containing 10 percent fat, on average, gained 6.4 pounds (11.9%) and 9.8 pounds (19.4%) more than the control group 1 and 2 animals, respectively.

The test group calves also consumed more calf starter than did animals fed the control milk replacers. Total starter intake of the animals in test group 2 was increased and animals, on average, consumed 8.8 pounds more (P<0.05) starter than the control group 1. The test group animals were also more efficient compared to the control group animals, and the test group required significantly less (P<0.05) total feed per unit gain compared with control group 1.

Summary:

The results of Example 1 were surprising and suggest that feeding calves milk replacers formulated to specific fatty acid levels can improve calf performance. In addition, in this Example, the calves fed milk replacer with a 10 percent fat content formulated to contain a specific fatty acid ratio surprisingly supported better performance than a 20 percent fat-containing calf milk replacer, meaning that even where the total fat in the milk replacer is reduced relative to traditional milk replacers, calves experienced improved performance. Further, no differences (P>0.05) in health or diarrhea data were noted in this Example, meaning that the health of the test group animals was not negatively affected by ingesting the milk replacers formulated with the specific fatty acid levels alone or in combination with the lowered fat content. Moreover, when the cost savings of formulating lower fat-containing milk replacer is considered, the fatty acid formulated milk replacers results in even greater efficiencies. For example, when the reduced ingredient cost is considered due to lower fat and protein levels, feeding the reformulated milk replacers is more efficient.

### Example 2

In Example 2, milk replacer formulations targeted to enhance early, more efficient gains by calves were studied. These full potential milk replacers contain high levels of milk protein and fat and are designed to be offered at higher feeding rates, generally in excess of 2.0 pounds of powder daily.

Procedures:

Seventy-two (72) calves with substantially the same age and weight as the calves in Example 1 were assigned by row, weight and initial gamma globulin levels into three groups of 24 calves in the manner provided in Example 1, and the groups were randomly assigned to three dietary treatments. In this Example, the protein in the milk replacers contained all-milk protein.

The control group received a high protein high fat milk replacer with 28 percent protein and 20 percent fat (Cow's Match®). The control milk replacer contained lard and lecithin as the sole fat sources. The first test group (test group 1) received a calf milk replacer with 27 percent protein and 10 percent fat with a modified fatty acid profile; and the second test group (test group 2) received a calf milk replacer with 26 percent protein and 10 percent fat with a modified fatty acid profile. For test groups 1 and 2, the fat in the fatty acid profile-modified milk replacers contained the reformulated fat blend in the percentages provided in Example 1 with the traditional fat blend of Example 1 to yield a 10 percent fat milk replacer.

All groups were fed at a 2.5 pound feeding rate, daily (split over two feedings) for six weeks. During the seventh week of this evaluation, milk replacer was reduced by half to facilitate calf weaning. A 22 percent protein calf starter was offered to all calves ad libitum.

Results:

Performance results of the calves fed the three different milk replacers during the seven-week treatment period are presented in Table 2.

TABLE 2
Performance results after dietary treatment for seven weeks

| | | 27:10 Fatty | 26:10 Fatty | |
|---|---|---|---|---|
| | 28:20 | Acid Test | Acid Test | |
| Dietary Treatment | Control | Group 1 | Group 2 | SE |
| Total Avg. Weight, lbs | 176.3 | 179.3 | 177.7 | 3.3 |
| Total Avg. Gain, lbs. | 70.7 | 73.6 | 72.1 | 2.8 |
| Total Avg. Starter Cons., | 25.2^{a} | 34.1^{b} | 35.2^{b} | 3.0 |
| lbs. (DM Basis) | | | | |
| Total Avg. CMR, lbs. | 100.8 | 103.1 | 101.9 | 1.2 |
| (DM Basis) | | | | |
| Average Feed:Gain | 1.8^{a} | 1.9^{ab} | 1.9^{b} | 0.0 |

^{ab}Means in the same row not followed by a common letter differ (P < .05) using LSD procedure.

Referring to the performance results of Table 2, for the control group, calves ingesting the full potential milk replacer with high protein and high fat gained a total of 70.7 pounds, on average. For the test groups 1 and 2, calves ingesting the fatty acid formulated milk replacers, on average, gained numerically more weight than the control group. For test group 1, calves ingesting the milk replacer with relatively lower protein and fat (e.g., 27 percent protein and 10 percent fat with the fatty acid formulation) outgained the control animals by 2.9 pounds (4.1%). For the test group 2, calves ingesting the milk replacer with a further reduced protein (e.g., 26 percent) and the relatively lowered fat content (e.g., 10 percent fat with the fatty acid formulation) compared to the control group outgained the control group animals by 1.5 pounds (2.1%).

Body measurements of calves fed these treatments are presented in Table 3.

TABLE 3
Average body measurements after dietary treatment for six weeks

| | 28:20 | 27:10 Fatty | 26:10 Fatty | |
|---|---|---|---|---|
| | Control | Acid Test | Acid Test | |
| Dietary Treatment | Group | Group 1 | Group 2 | SE |
| Hip height gain, cm | 7.2 | 8.0 | 7.6 | 0.5 |
| Hip girth gain, cm | 17.4 | 18.4 | 17.5 | 0.6 |
| Body length gain, cm | 14.1 | 15.0 | 14.4 | 0.9 |
| Body volume gain, 1 | 94.8 | 102.0 | 96.5 | 3.7 |

Referring to Table 3, although not significantly improved (P<0.05), body measurements (hip height, hip girth and body length) of calves fed the fatty acid formulated milk replacers had greater body dimensions. Body volume (liters) is a calculated measure employing the other three measurements ((hip height×(hip girth/3.14)×body length)/1000). Fatty acid formulated milk replacer fed calves had increased total body volumes of 7.2 and 1.7 liters, respectively.

Summary:

The results of Example 2 suggest that performance is maintained or enhanced for calves fed milk replacers with higher protein levels and modified for fatty acid balance compared with that of calves fed prior full potential milk replacers containing high protein and high fat levels (e.g., with the fat primarily derived from lard). In this Example, the test group calves fed a relatively reduced protein content and a 10 percent fat content including the reformulated fat blend with the specific fatty acid ratio supported better performance than a 20 percent fat containing CMR. In addition, general health and diarrhea data were not impacted by the test groups ingesting the reformulated milk replacers in Example 2, meaning that the health of the test group animals was not negatively affected by ingesting these reformulations. The reduction in milk protein and fat level in these fat reformulated treatments for test groups 1 and 2 represents substantial reductions in calf milk replacer cost and cost per unit gain. When the reduced ingredient cost is considered (reduced cost due to lower fat and protein levels), feeding the reformulated milk replacers is more efficient.

### Example 3

In this Example, milk replacers designed to support enhanced performance were studied.

Procedures:

Thirty-six (36) calves with substantially the same age and weight as the calves in Example 1 were assigned by row, weight and initial gamma globulin levels in the manner provided in Example 1, into two groups of 18 calves, and the groups were randomly assigned to two dietary treatments. In this Example, the milk replacers contained all-milk protein.

The control group received a full potential milk replacer with 28 percent protein and 20 percent fat (Cow's Match®). The control milk replacer contained lard and lecithin as the sole fat sources. For the test group, the fat in the fatty acid profile-modified milk replacer contained the reformulated fat blend including medium chain triglycerides at about 5.6 percent of the total weight of the milk replacer and canola oil at about 0.75 percent of the total weight of the milk replacer in combination with a traditional fat blend containing lard and lecithin to yield a 10 percent fat milk replacer.

Both groups were fed at a 2.5 pound feeding rate, daily (split over two feedings) for six weeks. During the seventh week, milk replacer was reduced by half to facilitate calf weaning. A 22 percent protein calf starter was offered to all calves ad libitum.

Results:

Performance results of the calves fed the two different milk replacers during the seven-week treatment period are presented in Table 4.

TABLE 4
Performance results after dietary treatment for seven weeks

| | 1 | 2 | | |
|---|---|---|---|---|
| | 28:20 | 27:10 Fatty | | |
| | Control | Acid Test | | |
| Dietary Treatment | Group | Group | P-Values | SE |
| Total Avg. weight, lbs. | 170.6 | 186.6 | <0.01 | 3.6 |
| Total Avg. Gain, lbs. | 71.8 | 79.5 | 0.15 | 3.7 |
| Total Avg. CMR, lbs. | 98.0 | 104.8 | <0.02 | 2.0 |
| (DM Basis) | | | | |
| Total Avg. Starter Cons., | 27.7 | 36.3 | 0.03 | 2.6 |
| lbs. (DM Basis) | | | | |
| Average Feed:Gain | 1.8 | 1.8 | 0.7 | 0.1 |

Referring to Table 4, for the control group, calves fed the traditional high protein high fat milk replacer gained a total of 71.8 pounds, on average. For the test group, calves ingesting the relatively lower protein and lower fat content milk replacer, on average, outgained the control animals by 7.8 pounds (10.8%). In addition, the test group consumed more (P<0.03) starter. Body volume gain of the calves in the test group was 18.5 liters greater (P>0.02) than for the control animals. As with Examples 1 and 2, no heath or diarrhea impact was noted for the test group fed the reformulated milk replacer.

Summary:

The results of Example 3 suggest that performance of calves fed milk replacers reformulated to contain a fatty acid balance is more efficient compared to full potential milk replacers containing fat solely in the forms of lard and lecithin. In Example 3, the test group calves ingesting the 10 percent fat, fatty acid reformulated milk replacer exhibited better performance than the control group ingesting the milk replacer with 20 percent fat. The reduction in milk protein and fat level in these fat reformulated treatments represents substantial reductions in milk replacer cost and cost per unit gain.

### Example 4

Value milk replacers often contain non-milk protein ingredients as a means to reduce total milk replacer cost. In this Example, protein sourced from soy was employed to determine the effects of the fatty acid reformulated fat component with vegetable-based proteins in milk replacers.

Procedures:

Sixty (60) calves with substantially the same age and weight as the calves in Example 1 were assigned by row, weight and initial gamma globulin levels, in the manner provided in Example 1, into three groups of 20 calves. The groups were randomly assigned to three dietary treatments. In this Example, the milk replacers in the three treatments included alternative, non-milk protein in the form of heat and alcohol-modified soy white flake. Approximately 50 percent of the total protein in the milk replacers was supplied by this non-milk protein source with the balance of the protein supplied as all-milk protein.

The control group received a milk replacer containing 22 percent protein and 20 percent fat (Maxi Care®). The control milk replacers contained lard and lecithin as the sole fat sources. The first test group (test group 1) received a calf milk replacer with 22 percent protein and 10 percent fat with a modified fatty acid profile, and the second test group (test group 2) received a calf milk replacer with 22 percent protein and 15 percent fat with a modified fatty acid profile. For test groups 1 and 2, the fat in the fatty acid profile-modified milk replacers contained the reformulated fat blend in the percentages provided in example 1 with the traditional fat blend of Example 1 to yield a 10 percent fat milk replacer and a 15 percent fat milk replacer, respectively.

All milk replacers were fed at a 1.5 pound feeding rate, daily (split over two feedings) for five weeks and then reduced by half to facilitate calf weaning during the sixth week. A 22 percent protein calf starter was offered to all calves ad libitum.

Results:

Performance results of the calves fed the three different milk replacers during the six-week treatment period are presented in Table 5.

TABLE 5
Performance results after dietary treatment for six weeks

| | 22:20 | 22:10 Fatty | 22:15 Fatty | |
|---|---|---|---|---|
| | Control | Acid Test | Acid Test | |
| Dietary Treatment | Group | Group 1 | Group 2 | SE |
| Total Avg. Weight, lbs. | 141.3^{ab} | 135.5^{a} | 147.6^{b} | 3.7 |
| Total Avg. Gain, lbs. | 45.7^{ab} | 39.6^{a} | 51.9^{b} | 3.5 |
| Total Avg. CMR, lbs. | 53.9^{ab} | 52.8^{a} | 55.7^{b} | 0.8 |
| (DM Basis) | | | | |
| Total Avg. Starter Cons., | 39.7 | 32.1 | 42.3 | 3.6 |
| lbs. (DM Basis) | | | | |
| Average Feed:Gain | 2.2 | 2.3 | 2.0 | 0.1 |

^{ab}Means in the same row not followed by a common letter differ (P < .05) using LSD procedure.

Referring to Table 5, for the control group, calves ingesting the alternative protein milk replacer gained a total of 45.6 pounds, on average. For the test group 2, calves ingesting the alternative protein and the 15 percent fat with the fatty acid content reformulated outgained the control group animals by 6.5 pounds (14.2%). Although not significant, total starter intake of the second test group was greater (P>0.05). Also, feed conversion appeared to be improved. Calves in test group 1 ingesting the 10 percent fat with the fatty acid content provided by the reformulated fat blend failed to outperform the control group calf in all aspects of performance measured. This suggests that milk replacer formulation and feeding rate, combined with use of the reformulated fat blend may dictate the needed final protein and fat level of a specific calf milk replacer.

Body measurements of calves fed these treatments are presented in Table 6.

TABLE 6
Average body measurements after dietary treatment for six weeks

| | 22:20 | 22:10 Fatty | 22:15 Fatty | |
|---|---|---|---|---|
| | Control | Acid Test | Acid Test | |
| Treatment | Group | Group 1 | Group 2 | SE |
| Body Measurements | | | | |
| Hip height gain, cm | 3.9^{ab} | 3.0^{a} | 4.7^{b} | 0.5 |
| Hip girth gain, cm | 10.5^{a} | 11.0^{a} | 14.0^{b} | 0.8 |
| Body length gain, cm | 7.0^{a} | 10.1^{b} | 9.6^{ab} | 1.0 |
| Body volume gain, 1 | 47.1^{a} | 53.6^{ab} | 63.5^{b} | 4.3 |

Referring to Table 6, total body volume gain in this trial was improved for the test group calves fed milk replacers formulated on a fatty acid basis. For test group 2, the calves, on average, had an increased volume gain of 16.4 liters (P<0.05) compared to the control group. As with the other Examples, health and diarrhea scores were not different among treatments.

Summary: The results of Example 4 also suggest that performance of calves fed milk replacers formulated for fatty acid balance can be more efficient. In this trial, calves fed a 15 percent fat formulated to contain a specific fatty acid ratio and alternative protein-containing milk replacer supported better performance than a 20 percent fat milk replacer containing the same alternative protein.

As used herein, standard error (“SE”) is the standard deviation of the sample in a frequency distribution, obtained by dividing the standard deviation by the total number of cases in the frequency distribution. “P” used in the Tables above is a probability value. For purposes of comparing data in this document, P values of 0.05, or lower, are considered to be statistically significant.

While the present disclosure provides various ranges, it will be understood that values, such as numeric integer values, at or within these ranges, or various ranges within the disclosed ranges, or ranges beginning or ending at a range value and beginning or ending at a value within the disclosed ranges, may be used in particular embodiments without departing from the aspects of the present disclosure.

Although the present disclosure provides references to preferred embodiments, persons skilled in the art will recognize that changes may be made in form and detail without departing from the spirit and scope of the invention.

What is claimed is:

1. A milk replacer product for young animals, the milk replacer comprising a fat content of up to about 20 percent on a dry matter basis, the fat content comprising at least about 10 percent medium chain triglycerides on a dry matter basis.

2. The product of claim 1, wherein the fat content comprises up to about 40 percent of medium chain triglycerides on a dry matter basis.

3. The product of claim 1, the fat content further comprising a ratio about 2:1 to about 7:1 of medium chain fatty acids to supplemental essential fatty acids on a dry matter basis.

4. The product of claim 1, wherein the medium chain triglycerides comprise one or more of caprylic acid and capric acid.

5. The product of claim 1, wherein the medium chain triglycerides comprise caprylic fatty acids between about 20 percent to about 80 percent and capric fatty acids between about 20 to about 80 percent of the medium chain triglycerides.

6. The product of claim 1, wherein the milk replacer comprises a protein content of up to about 27 percent by weight on a dry matter basis.

7. The product of claim 6, wherein the protein content includes milk protein and a non-milk protein in an amount up to about 65 percent on a dry matter basis.

8. The product of claim 7, wherein the non-milk protein comprises vegetable protein, animal protein, single cell proteins and combinations thereof.

9. A method of feeding milk replacer to a young animals, the method comprising:
providing the young animals a milk replacer comprising medium chain triglycerides, wherein the medium chain triglycerides are ingested by the young animals at a rate of at least about 13.5 grams per head per day.

10. The method of claim 9, wherein the medium chain triglycerides are ingested by the young animals at a rate of up to about 68.1 grams per head per day.

11. The method of claim 9, wherein the milk replacer further comprises supplemental fatty acids, and wherein the supplemental fatty acids are ingested by the young animals at a rate of at least about 1.5 grams per head per day.

12. The method of claim 11, wherein the supplemental fatty acids are ingested by the young animals at a rate of up to about 11.4 grams per head per day.

13. The method of claim 9, wherein the milk replacer is provided at a rate of at least 1.5 pounds per head per day.

14. The method of claim 13, wherein the milk replacer is provided at a rate of up to 2.5 pounds per head per day.

15. The method of claim 9, wherein the milk replacer includes a total fat content of up to about 35 percent on a dry matter basis.

16. The method of claim 15, wherein the milk replacer includes a total fat content of at least about 10 percent on a dry matter basis.

17. The method of claim 9, wherein the young animals are animals in a pre-weaning stage.

18. A method of making a milk replacer for young animals, the method comprising:
adding medium chain triglycerides to a milk replacer formulation such that the milk replacer product includes at least about 9 grams of medium chain triglycerides per pound of milk replacer on a dry matter basis.

19. The method of claim 18, wherein the milk replacer formulation includes a total fat content of up to about 35 percent on a dry matter basis.

20. The method of claim 18, further comprising adding supplemental fatty acids to a milk replacer formulation such that the milk replacer product includes at least about 1.15 grams of the supplemental fatty acids per pound of milk replacer on a dry matter basis.
